(19) United States
(12) Patent Application Publication
(10) Pub. No.: US 2005/0149367 A1
(43) Pub. Date: Jul. 7, 2005

(54) Inter-enterprise collaborative process management system

(76) Inventors: Kang Woo Lee, Taejon (KR); Youngho Suh, Kwangju (KR); Hyun Kim, Taejon (KR)

Correspondence Address: JACOBSON, PRICE, HOLMAN & STERN;PROFESSIONAL LIMITED LIABILTY COMPANY, 400 Seventh Street, N.W., Washington, DC, 20004, US

(21) Appl. No.: 10/876,649

(22) Filed: Jun. 28, 2004

(30) Foreign Application Priority Data
Dec. 23, 2003 (KR) 2003-95253

(51) Int. Cl. G06F 17/60; H04L 9/00; H04K 1/00

(52) U.S. Cl. 705/7; 705/80

(57) ABSTRACT

The present invention relates an inter-enterprise collaborative process management system that manages all the processes and other computer systems of the participating companies by making all the processes and other computer systems of the participating companies interwork with each other so that various specialized companies are integrated in one virtual enterprise and the virtual enterprise is run. An inter-enterprise collaborative process management system includes: a collaborative process editor for defining, modifying and deleting a collaborative process through a user interface; a collaboration policy editor for defining, modifying and deleting a collaboration policy through a user interface; a collaborative partner selector for searching for a candidate partner of performing each activity of the collaborative process and helping selecting a most proper partner of the found candidate partners; a collaborative process agent for, when the collaborative partner is selected, performing an actual collaborative activity by using a service supplied by the selected partner; a collaborative process engine for transferring a result of the activity completed by the collaborative process agent as an input of a next activity and calling a corresponding collaborative process agent; and a collaboration agency for controlling and managing inter-enterprise collaborative activity on the basis of the collaboration policy.

### BACKGROUND OF THE INVENTION

1. Field of the Invention

The present invention relates to an inter-enterprise collaborative process management system which manages all the processes and other computer systems of the participating companies by making the collaborate with each other so that various specialized companies can be integrated to dynamical form and operate a virtual enterprise.

The inter-enterprise collaborative process management system provides various system-support required at each phase during a lifecycle of a virtual enterprise. The system support enables a virtual enterprise to define its business processes by integrating the business processes, data and application systems of the participating companies and to automate execution of the processes. The present invention relates an inter-enterprise collaborative process management system that has characteristics as described above.

2. Description of the Related Art

As the conventional system that is the most similar to this concept, a cross-organizational workflow management or an inter-enterprise management system has been suggested. However, the conventional system provides only rudimentary support for operating the virtual enterprise in the sense that it does not support following functions. First, the conventional system does not support the entire lifecycle of the virtual enterprise. Second, the conventional system does not support the multiple participating companies to perform one activity by collaborating in an inter-enterprise process. Third, the conventional system does not support the function of dynamically selecting a partner to perform an activity. Fourth, the conventional system has limitation pm integrating processes and applications of a plurality of companies due to using the restricted middleware such as, CORBA, EJB and JMS.

However, the number of virtual companies each consisting of specialized enterprises will be increased in the future enterprise environment. Then inter-enterprise collaborative process management system is required to support above functions in order to manage and operate virtual enterprise more effectively in the future enterprise settings.

### SUMMARY OF THE INVENTION

Accordingly, the present invention is directed to an inter-enterprise collaborative process management system, which substantially obviates one or more problems due to limitations and disadvantages of the related art.

It is an object of the present invention to provide an inter-enterprise collaborative process management system, which integrates processes and automates activity flow of the processes with increase of highly specialized companies for specific activities so that various specialized companies are dynamically integrated and operated as one virtual enterprise on Internet virtual space.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, there is provided an inter-enterprise collaborative process management system including: a collaborative process editor for defining, modifying and deleting a collaborative process through a user interface; a collaboration policy editor for defining, modifying and deleting a collaboration policy through a user interface; a collaborative partner selector for searching for a candidate partner to perform each activity of the collaborative process and helping selecting a most proper partner of the candidate partners; a collaborative process agent for, when the collaborative partner is selected, performing an actual collaborative activity by using a service provided by the selected partner; a collaborative process engine for transferring a result of the activity completed by the collaborative process agent as an input of a next activity and calling a corresponding collaborative process agent; and a collaboration agency for controlling and managing inter-enterprise collaboration on the basis of the collaboration policy.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention, are incorporated in and constitute a part of this application, illustrate embodiments of the invention and together with the description serve to explain the principle of the invention. In the drawings:

FIG. 1 illustrates a lifecycle of a virtual enterpriose applied to a management system of the present invention;

FIG. 2 illustrates an overall architecture of an inter-enterprise collaborative process management system according to an embodiment of the present invention;

FIG. 3 illustrates a step of defining a collaborative process in an inter-enterprise collaborative process management system according to an embodiment of the present invention;

FIG. 4 illustrates a step of searching for candidate collaborative partner, and selecting and integrating a collaborative partner in an inter-enterprise collaborative process management system according to an embodiment of the present invention;

FIG. 5 illustrates a step of operating a virtual enterprise in an inter-enterprise collaborative process management system according to an embodiment of the present invention;

FIG. 6 illustrates a detailed architecture of the collaboration agency of FIG. 2; and

FIG. 7 illustrates an example of collaboration policy applied to an inter-enterprise collaborative process management system according to an embodiment of the present invention.

### DETAILED DESCRIPTION OF THE INVENTION

Reference will now be made in detail to the preferred embodiments of the present invention, examples of which are illustrated in the accompanying drawings.

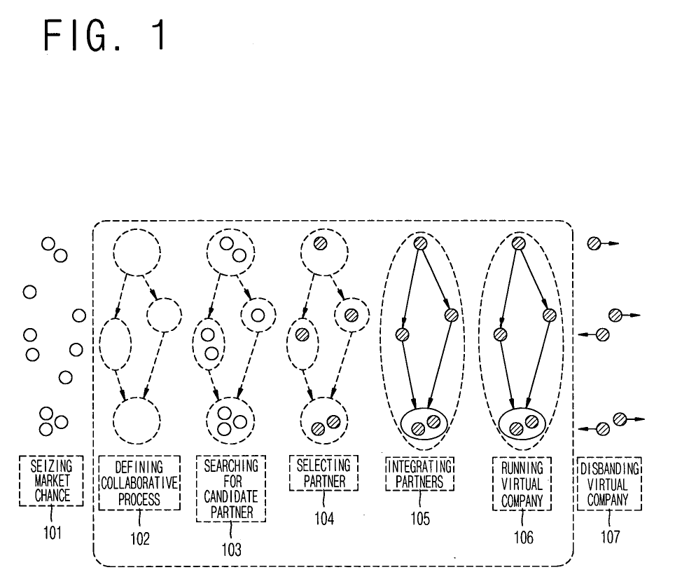

A virtual enterprise does not exist physically but is established by integrating various conventional specialized companies (of small or medium scale). The virtual enterprise is dynamically established or disbanded depending on the interests of the component companies. The virtual enterprise applied to an inter-enterprise collaborative process management system according to an embodiment of the present invention has a lifecycle illustrated in FIG. 1. FIG. 1 illustrates a lifecycle of a virtual enterprise applied to a management system of the present invention.

As shown in FIG. 1, the first lifecycle of the virtual enterprise is a market chance seizure step 101 of seizing a new chance of a market. At this step 101, seized is a motivation for establishing a virtual enterprise for a new market.

The second lifecycle of the virtual enterprise is a collaboration process definition step (102) for editing a business process for a market for which a chance is seized. The process edited at this time is performed by collaboration of various companies that participate in the virtual enterprise to be established. This is called inter-enterprise collaborative process.

The third lifecycle of the virtual enterprise is a candidate partner search step (103) for searching for a candidate partner company to perform each activity constituting a defined collaborative process. Generally, at this step (103), a plurality of candidate companies are searched for.

The fourth lifecycle of the virtual enterprise is a partner selection step (104) for selecting a most proper partner being actually perform each activity among the candidate partners found at the candidate partner search step (103). All the activities constituting a collaborative process do not have to be performed by one partner. In this case, the activity may be performed by collaboration of various companies. In this specification, such activity is called collaborative activity. In this case, multiple partner companies are selected.

The fifth lifecycle of the virtual enterprise is a partner integration step (105) for, after selecting a partner for performing each activity, integrating resources of the selected companies, which are necessary to perform the collaborative process, such as a process management system run by each company, an enterprise resource planning (ERP) system and a legacy application program, so that the collaborative process is automatically performed. The partner integration includes integration of exchangeable resources as well as integration of processes of the companies.

The sixth lifecycle of the virtual enterprise is a virtual enterprise operating step (106) for making the various companies that participate in a virtual enterprise interwork with each other through the collaborative process, and performing the activity of the virtual enterprise. The virtual enterprise operating step (106) includes modifying and supplementing a collaborative process and replacing a partner as well as performing a simple collaborative process. Modifying and supplementing a collaborative process and replacing a partner can be caused in operating the virtual enterprise.

The seventh lifecycle of the virtual enterprise is a virtual enterprise disbanding step (107), which is the last step, for disbanding the virtual enterprise when it is not any more necessary to run the virtual enterprise. If the virtual enterprise is disbanded, all the connection between the integrated computing systems of the companies is released.

The inter-enterprise collaborative process management system according to an embodiment of the present invention supports the steps from the collaborative process definition step (102) to the virtual enterprise operating step (106) of the lifecycle of the virtual enterprise described above and provides tools and systems available at each step.

One of the characteristics of the inter-enterprise collaborative process management system according to an embodiment of the present invention is that the management system does not have to be developed from the beginning but the business process management system (BPMS) that has been used by the conventional company can be utilized. In other words, a part of defining a business process, a part of controlling each activity so that the defined business process is performed according to defined order and transferring data between the activities, a part of calling an application program for performing the activity, and a part of ensuring the reliability of performing the process can be utilized.

The inter-enterprise collaborative process management system according to an embodiment of the present invention expands the functions of parts that cannot be controlled by the conventional BPMS by using an agent technique. The part that can be expanded using the agent technique includes a candidate partner search part, a part for selecting a most proper partner of the found candidate partners, a part for making computing systems of the companies interwork with each other by using web-services, and a part for processing inter-enterprise collaboration when an activity should be performed by collaboration of multiple companies.

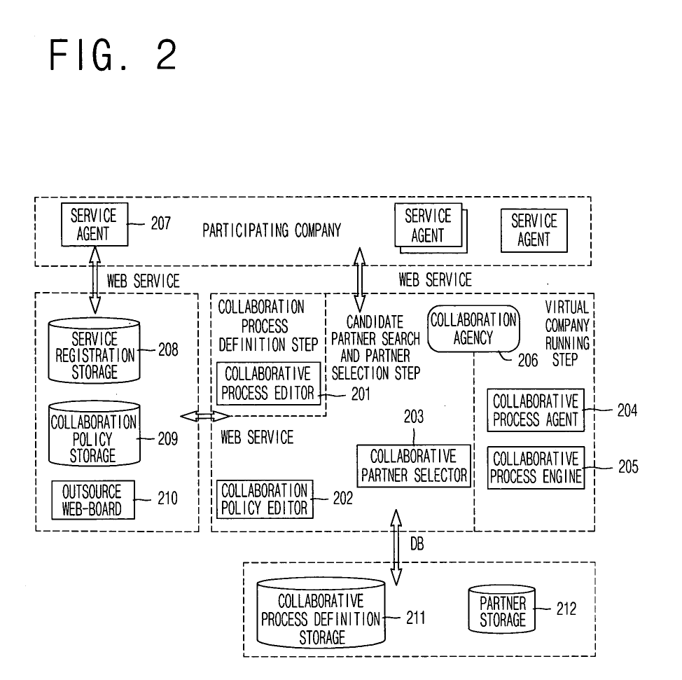

FIG. 2 illustrates an overall architecture of an inter-enterprise collaborative process management system according to an embodiment of the present invention.

The inter-enterprise collaborative process management system according to an embodiment of the present invention provides a tool and a subsystem to be used at each step of a lifecycle of a virtual enterprise described above, and manages a storage for storing various kinds of information necessary to perform a collaborative process.

The inter-enterprise collaborative process management system according to an embodiment of the present invention includes a collaborative process editor 201, a collaboration policy editor 202, a collaborative partner selector 203, a collaborative process agent 204, a collaborative process engine 205 and a collaboration agency 206.

Each of the participating companies connects to the inter-enterprise collaborative process management system through a web-service provided by a service agent 207. A collaborative process definition storage 211 and a partner storage 212 are provided to allow the inter-enterprise collaborative process management system can exclusively access to the storage 211 and 212. A service registration storage 208, a collaboration policy storage 209 and an outsource web-board 210 are provided to allow the service agent 207 and the inter-enterprise collaborative process management system can access to the storages 208, 209 and 210.

Referring to FIG. 2, the collaborative process editor 201 is a tool for helping defining a collaborative process and allows a process composer to easily define, modify and delete the collaborative process through a user interface.

The collaboration policy editor 202 is a tool for helping defining a collaboration policy and allows a collaboration policy maker to easily define, modify and delete a collaboration policy through a user interface.

The collaborative partner selector 203 is a tool for helping searching for a candidate partner of performing each activity of the collaborative process and helping selecting a most proper partner of the found candidate partners.

The collaborative process agent 204 performs an actual collaborative activity by using a service supplied by the selected partner after the collaborative partner is selected.

The collaborative process engine 205 is a subsystem for managing workflow of activities constituting the collaborative process, transfers a result of the activity completed by the collaborative process agent 204 as an input of a next activity and calls a corresponding collaborative process agent.

The collaboration agency 206 is a subsystem for controlling and managing the collaboration of companies when multiple companies are required to collaborate with each other, and performs inter-enterprise collaborative activity on the basis of the collaboration policy. The collaboration agency 206 is used when one activity is performed by multiple companies at the partner selection step (104) and the virtual enterprise operating step (106).

The service registration storage 208 is a place to which a company that would like to participate in a virtual enterprise registers a service that the company can provide. The registered services are classified in predetermined classification way so as to be easily searched for.

The collaboration policy storage 209 stores the collaboration policy edited by the collaboration policy editor 202.

The outsource web-board 210 discloses a suggestion request at the partner selection step 104 shown in FIG. 1 when the plurality of candidate partner is found, so that suggestion is received and the most proper partner is selected. Each participating company can submit suggestion for a corresponding activity on the basis of the contents disclosed in the outsource web-board 210.

The collaborative process definition storage 211 stores definition of the collaborative process edited by the collaborative process editor 201. The partner storage 212 stores information of the selected partner when the partner is selected through the collaborative partner selector 203. This information is used to request the partner disclosed in the partner storage 212 to perform an activity when the actual collaborative process is performed and the corresponding activity is performed later.

As described above, the service agents 207 of participating companies and the inter-enterprise collaborative process management system of the present invention can access to the service registration storage 208, the collaboration policy storage 209 and the outsource web-board 210 of the storages through web services. However, the collaborative process definition storage 211 and the partner storage 212 allow only the inter-enterprise collaborative process management system of the present invention to exclusively access to themselves.

The companies which are participating or would like to participate in the virtual enterprise register their service to the service registration storage 208 through the service agent 207 so that their services can be used for a collaborative process.

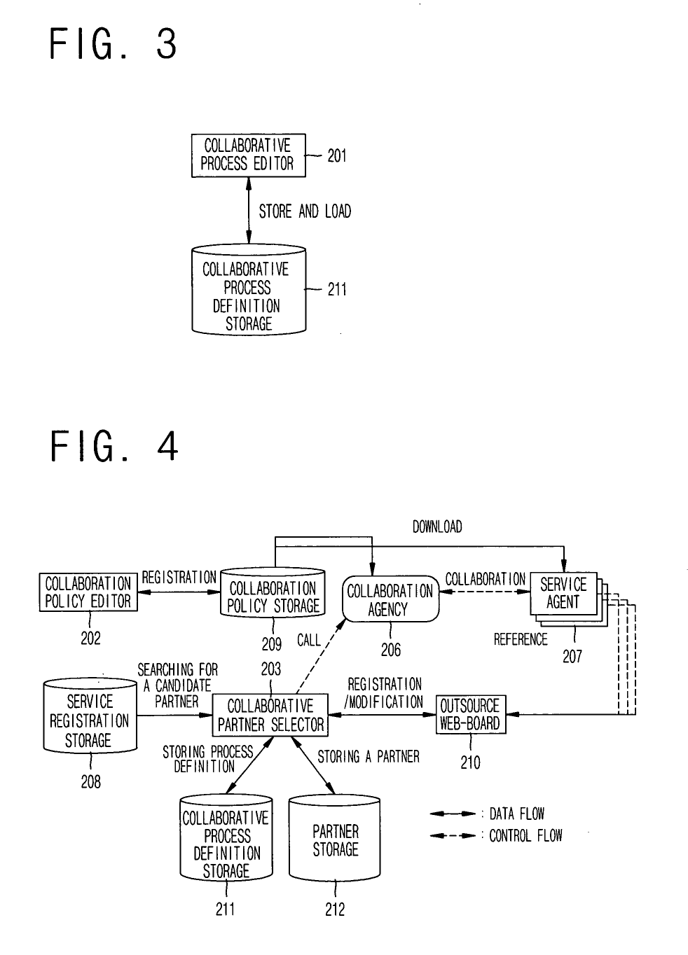

FIG. 3 illustrates a step of defining a collaborative process in an inter-enterprise collaborative process management system according to an embodiment of the present invention.

The collaborative process editor 201 shown in FIG. 1 provides a user interface to compose a collaborative process definition. In the collaborative process, a performer for performing each activity is not designated contrast to general business process. The actual performer is designated later at the candidate partner search steps and the partner selection step. The collaborative process composed using the collaborative process editor 201 is stored in the collaborative process definition storage 211 and can be used later when the collaborative process is performed.

FIG. 4 illustrates a step of searching for candidate collaborative partner, and selecting and integrating a collaborative partner in an inter-enterprise collaborative process management system according to an embodiment of the present invention.

Referring to FIG. 4, the collaborative partner selector 203 is a user interface tool for supporting the step of searching for a candidate partner and all the step including the step of integrating resources of the selected companies, and calls a tool and a subsystem necessary for each step. The service registration storage 208 is a place to which a company that would like to participate in a virtual enterprise registers a service that the company can provide in the form of the service agent 207. The service agent 207 plays as a gateway to access to the service provided by the corresponding company in the form of the web service. The service registration storage 208 classifies the registered service agents 207 systematically according to the activities performed by registered service agents 207, and provides directory functions so that the a collaborative partner selector 203 can search easily for a service agent 207 that provides a desired service. Accordingly, the collaborative partner selector 203 selects the agent that has the function required by each activity among the service agents of the partners registered to the service registration storage 208.

The collaborative process composer searches for multiple candidate partners of performing each activity and selects the most proper partner of the found candidate partners. The partner selection step is performed in two ways: a first method of selecting the partner in advance according to a predetermined policy or inter-enterprise contracts, and a second method of receiving suggestions from the candidate partners and selecting the candidate partner who suggested the best condition.

The second method is required first to provide public notice that a partner is selected for the designated activity. The public notice is performed through the outsource web-board 210. The information disclosed on the outsource web-board includes object activity identifier, detailed description of the activity to be performed, collaboration policy to be used to select a partner and a service technical document composed by WSDL for access to the collaboration agency to perform selection, and further includes the collaboration policy to be used for the collaboration if the activity to be performed is performed by multiple companies.

The company that would like to participate in the partner selection through the outsource web-board 210 registers the service agent 207 to perform selection to the corresponding collaboration agency 206. The participating company participates in partner selection through the service agent 207.

The collaboration agency 206 performs partner selection through the collaboration of a company that selects a partner and a company that would like to be a partner. The collaboration policy required for a partner selection can be downloaded from the collaboration policy storage 209 and used. If there is not any proper collaboration policy, the collaboration policy can be composed using the collaboration policy editor 202.

The selected partner information is stored in the partner storage 212 and will be used to request the selected partner to perform the corresponding activity later while the collaborative process is performed. The information is stored in the partner storage 212 is recorded as a pair of an activity identifier and a service description document composed with WSDL that can access to the selected service agent 207.

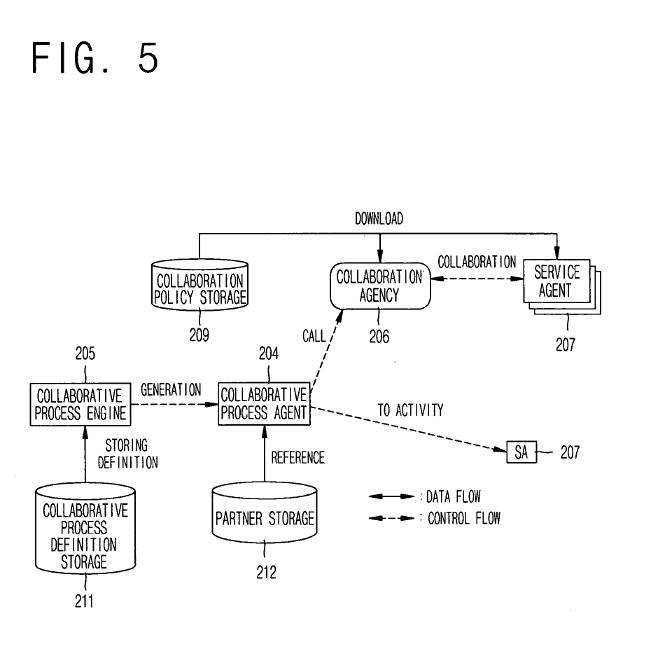

FIG. 5 illustrates a step of operating a virtual enterprise in an inter-enterprise collaborative process management system according to an embodiment of the present invention.

Referring to FIG. 5, the collaborative process engine 205 is an engine for performing the collaborative process, and performs the activity similar to the conventional BPMS engine, such as the activity of controlling activity performance and transmitting and receiving data between activities. The definition information necessary to process the collaborative process is read from the collaborative process definition storage 211 and used. Therefore, the conventional BPMS engine may be employed as the collaborative process engine 205 employed in the present invention.

However, for the activity constituting the collaborative process, the information on a performer is included in a process definition but the information on a performer stored in the partner storage 212 is used contrast to that of the conventional BPMS. Since one activity is frequently performed by the collaboration of multiple performers (partners), the conventional BPMS engine cannot be used as itself for the collaboration case.

Accordingly, the collaborative process engine 205 defines all the activities constituting the collaborative process as an application activity. The application activity is one kind of the activity. When the activity is started, the activity is performed in the way to execute an application program (or module) designated in advance.

In the present invention, all the activities are defined as application activities. The designated application is set as the collaboration process agent 204. When the activity is performed, the collaboration process agent 204 is called. When the collaboration process agent 204 is called, the partner information determined for each activity at the previous partner selection step is read from the partner storage 212 and the corresponding partner is requested to perform the activity. In other words, the collaborative process used by the virtual enterprise is performed using the conventional BPMS through the collaboration process agent 204.

The collaboration process agent 204 has two main jobs. First, the collaboration process agent 204 accesses to the partner storage 212 and searches for the partner company to perform an activity. Second, the collaboration process agent 204 requests the partner company to perform an activity. If the activity is performed by a single partner, the collaboration process agent 204 calls the service agent 207 of the corresponding partner to requests the partner company to perform an activity. If the activity is performed by multiple partners, the collaboration process agent 204 generates a collaboration agency 206 to perform collaboration and performs the collaboration through the collaboration agency 206.

The collaboration agency 206 downloads collaboration policy used in the collaboration from the collaboration policy storage 209 and controls collaboration of the service agents 207 of the participating partners. If the activity is performed by multiple companies, the collaboration policy is a document in which the method of collaboration of them is described as an XML document.

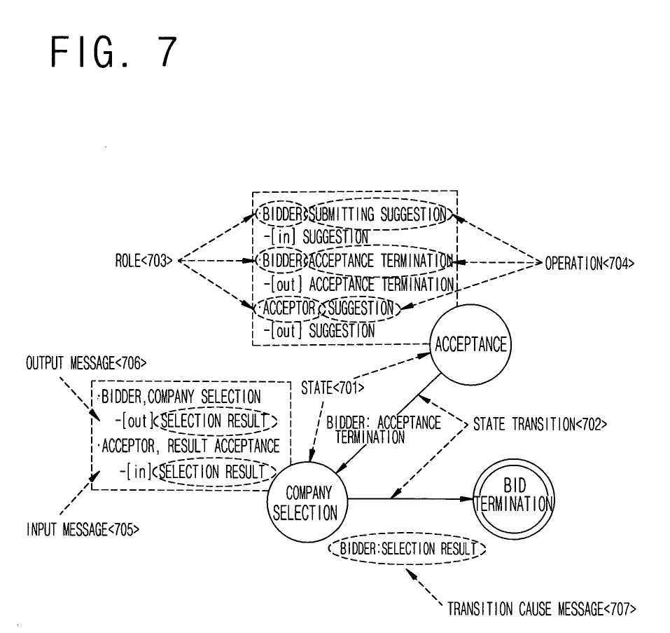

FIG. 7 illustrates an example of collaboration policy applied to an inter-enterprise collaborative process management system according to an embodiment of the present invention.

The collaboration policy shown in FIG. 7 is a state transition diagram and describes transition process of the main states in collaboration. FIG. 7 illustrates a collaboration policy describing the process of selecting a final accepting company by collaboration of a bidding company and an accepting company in bidding process.

Referring to FIG. 7, illustrated is an example of the collaboration policy consisting of the state 701 of “acceptance”, “company selection” and “bid termination”. The collaboration policy describes a role 703 given to the companies participating in the collaboration to describe the collaboration process performed in each state, and operation 704 of performing each role. In the example shown in FIG. 7, it is found that the companies of a role of “bidder” and companies of a role of “acceptor” collaborate with each other in the “acceptance” state. It is described that the company of a role of “acceptor” performs an operation of “suggestion.” Each operation 704 is described by an input message 705 necessary for performance and an output message 706 generated as a result of performance. In the example of FIG. 7, it is found that the operation “company selection” performed by the company that has a role of “bidder” of the “company selection” state is defined to have the output message of “selection result”, and the operation “result acceptance” performed by the company that has a role of “acceptor” of the “company selection” state is defined to have an input message of “selection result.”

The message flow caused by an input message and an output message of operation performed by the participating companies can be inferred through collaborative technique of each state of the collaboration policy. In FIG. 7, in the state “company selection”, the company of a role of “bidder” transmits the data “selection result” generated as the result of the activity “company selection” to the companies of a role of “acceptor” through the operation “result acceptance.”

The state transition 702 of the collaboration policy is caused by a message generated by a specific role participating in each state. In the specification, the message that causes the state transition is called transition cause message 707. referring to the example, the state is transited from the state “company selection” to the state “bid termination” when a “bidder” generates the message “selection result” at the state “company selection.”

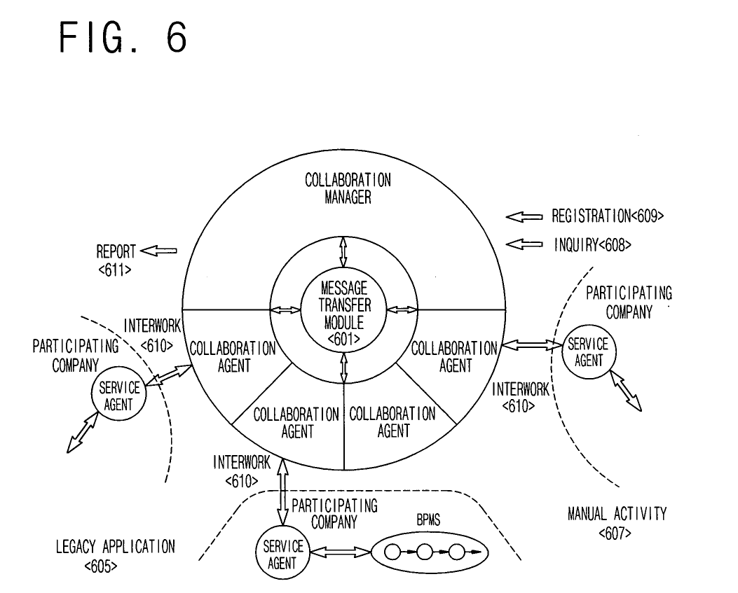

FIG. 6 illustrates a detailed architecture of the collaboration agency of FIG. 2. The collaboration agency 206 interacts with the outside through the interface in the form of inquiry 608, registration 609, interwork 610 and report 611. A company can inquire the following contents about the collaboration agency 206 through the inquiry 608: a collaboration policy identifier used by the collaborative agency 206 to control collaboration, a current state of collaboration policy in collaboration, and information of roles that can participate in collaboration. The information includes a service technical document composed of description of each role and services provided by the company having a role with WSDL as inquiry.

When a company would like to participate in collaboration through registration interface 609, the company can register its services to the collaboration agency 206 by using a registration interface 609. The information necessary for the company to register its service to the collaboration agency 206 includes a name of a role that the company wants and a service technique of a service agent to be called by the collaboration agency 206 in actual collaboration.

When registration is submitted, the collaboration manager determines whether or not to approve registration and informs the submitting company of the result of the determination. When approving registration, the collaboration manager generates collaboration agent and allocates the generated collaboration agent to the corresponding company. The collaboration agent is an agent representative of a service agent provided by the company, and interworks with another collaboration agent that participates in collaboration to perform the collaboration.

The interwork 610 means the actual collaborative activity performed by the registered companies after finishing all the necessary registration process. The collaboration is performed through the collaboration agents allocated to the registered company. The collaboration manager controls the collaboration so that collaboration of the collaboration agents can be performed according to the given collaboration policy.

A message is exchanged between the collaboration agents through the message transfer module 601. The collaboration agent calls the service agent to perform an operation of the corresponding service agent through web service when the collaboration agent has any operation that a company should process in collaboration.

The service agent plays as a gateway that allows various resources of the company, for example, legacy application 605, BPMS, and other manual activities to access to the collaboration agent through service. The collaboration manager participates in collaboration through report 611 and reports collaboration proceeding information to an object that is interested in the collaboration proceeding information.

As described above, with increase of highly specialized companies, this invention can provide an inter-enterprise collaborative process management system, which integrates resources of the companies and integrates and automates activity flow processes so that various specialized companies are dynamically integrated and run as one virtual enterprise on Internet virtual space.

It will be apparent to those skilled in the art that various modifications and variations can be made in the present invention. Thus, it is intended that the present invention covers the modifications and variations of this invention provided they come within the scope of the appended claims and their equivalents.

1. An inter-enterprise collaborative process management system, the system comprising:
a collaborative process editor for defining, modifying and deleting a collaborative process through a user interface;
a collaboration policy editor for defining, modifying and deleting a collaboration policy through a user interface;
a collaborative partner selector for searching for a candidate partner of performing each activity of the collaborative process and helping selecting a most proper partner of the found candidate partners;
a collaborative process agent for, when the collaborative partner is selected, performing an actual collaborative activity by using a service supplied by the selected partner;
a collaborative process engine for transferring a result of the activity completed by the collaborative process agent as an input of a next activity and calling a corresponding collaborative process agent; and
a collaboration agency for controlling and managing inter-enterprise collaborative activity on the basis of the collaboration policy.

2. The system of claim 1, wherein the system supports the steps of:
(a) editing a business process for a market for which a chance is seized;
(b) searching for a candidate partner company to perform each activity constituting a defined collaborative process;
(c) selecting a most proper partner of the found candidate partners, the most proper partner being going to perform each activity actually;
(d) integrating resources of the selected companies so as to automatically perform the collaborative process, the resources being necessary to perform the collaborative process; and
(e) making the selected companies interwork with each other through the collaborative process, the selected companies participating in a virtual enterprise.

3. The system of claim 1, wherein the system is configured to exclusively access to:
a collaborative process definition storage for storing definition of the collaborative process edited by the collaborative process editor; and
a partner storage for storing information of the partner selected through the collaborative partner selector.

4. The system of claim 1, wherein the system is configured to access to:
a service registration storage to which a company that would like to participate in a virtual enterprise registers a service that the company can provide;
a collaboration policy storage for storing the collaboration policy edited by the collaboration policy editor; and
an outsource web-board for disclosing a suggestion request when the plurality of candidate partner is found, so that suggestion is received and the most proper partner is-selected.

5. The system of claim 1, wherein, when the activity is started, the collaborative process engine calls the collaborative process agent, reads partner information from a partner storage, and requests the corresponding partner to perform the collaborative activity.

6. The system of claim 1, wherein the collaboration agency comprises:
a collaboration agent for being representative of a company participating in collaboration and performing collaborative activity;
a collaboration manager for controlling collaboration between the collaboration agents; and
a message transferring module for transferring information between the collaboration agents.

7. The system of claim 1, wherein the collaboration agency supports:
an inquiry interface for providing the company that would like to participate in collaboration with information used to constitute a service agent necessary for collaboration;
a registration interface through which the company that would like to participate in collaboration participates in the collaboration as a predetermined role by using the constituted service agent;
an interworking interface for interworking between the collaboration agent and the service agent so as to request the participating company to perform a corresponding collaborative activity in collaboration; and
a report interface for transferring progress status to an external company or another system in collaboration.

8. The system of claim 6, wherein the collaboration agency supports:
an inquiry interface for providing the company that would like to participate in collaboration with information used to constitute a service agent necessary for collaboration;
a registration interface through which the company that would like to participate in collaboration participates in the collaboration as a predetermined role by using the constituted service agent;
an interworking interface for interworking between the collaboration agent and the service agent so as to request the participating company to perform a corresponding collaborative activity in collaboration; and
a report interface for transferring progress status to an external company or another system in collaboration.
